(19) United States
(12) Patent Application Publication
(10) Pub. No.: US 2021/0063906 A1
(43) Pub. Date: Mar. 4, 2021

(54) LIQUID DEVELOPER

(71) Applicant: CANON KABUSHIKI KAISHA, Tokyo (JP)

(72) Inventors: Yuzo Tokunaga, Chiba-shi (JP); Tomoyo Miyakai, Tokyo (JP); Takashi Hirasa, Moriya-shi (JP); Hayato Ida, Toride-shi (JP); Yasutaka Akashi, Yokohama-shi (JP)

(21) Appl. No.: 16/996,461

(22) Filed: Aug. 18, 2020

(30) Foreign Application Priority Data
Aug. 30, 2019 (JP) 2019-158452

(51) Int. Cl. G03G 9/13; G03G 9/135

(52) U.S. Cl. CPC G03G 9/131; G03G 9/1355

(57) ABSTRACT

A liquid developer that can show excellent adhesiveness with respect to plastic film media even if a base layer is not formed, the liquid developer includes a toner particle and a carrier liquid, where the toner particle contains a resin including a monomer unit (1) represented by the formula (1).

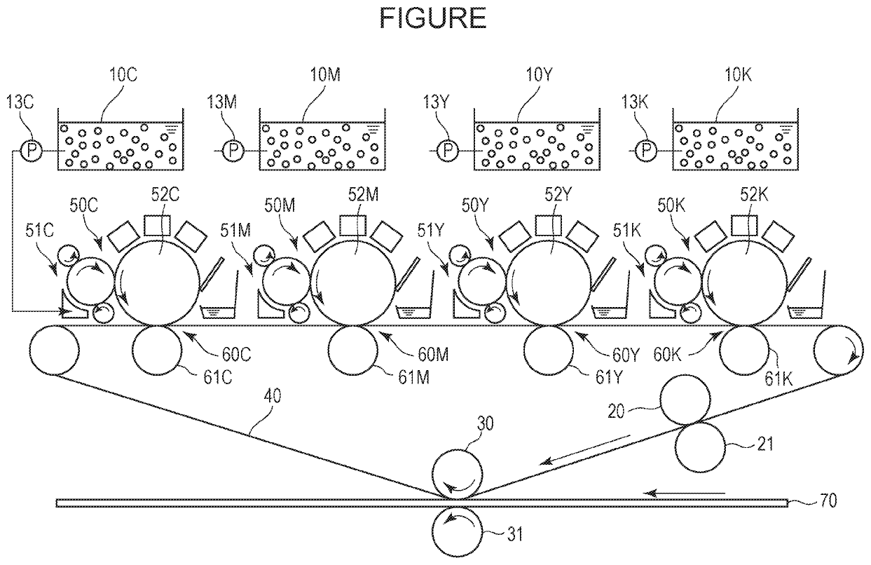

### BACKGROUND OF THE INVENTION

### Field of the Invention

The present disclosure relates to a liquid developer that is used in an image-forming apparatus (electrophotographic apparatus) employing an electrophotographic method.

### Description of the Related Art

An electrophotographic method is a method for forming an image by charging an surface of an electrophotographic photosensitive member (charging step), irradiating the surface of the electrophotographic photosensitive member with image exposure light to form an electrostatic latent image (exposure step), developing the electrostatic latent image with a developer (toner) to form a toner image on the surface of the electrophotographic photosensitive member (developing step), transferring the toner image to a recording medium, such as paper or a plastic film (transferring step), and fixing the transferred toner image to the recording medium (fixing step).

The developer is roughly classified into a dry developer using toner particles containing a coloring agent and a binder resin in a dry system state, and a liquid developer in which toner particles containing a coloring agent and a binder resin are dispersed in a carrier liquid (electrically insulative liquid).

In recent years, a need for higher image quality of an electrophotographic apparatus is increasing.

As developers that can meet the need for higher image quality, liquid developers are drawing attention. Since the liquid developers hardly cause aggregation of the toner particles therein even if they are stored for a long period, toner particles having a small particle diameter can be used. Accordingly, images having high image quality and excellent fine line reproducibility and tone reproducibility can be obtained by using a liquid developer. Development of high image quality digital printers taking advantage of this feature of liquid developers and using an electrophotographic technology is becoming active. Under such circumferences, a liquid developer having better characteristics is demanded.

In a general method for fixing a liquid developer, the liquid developer forming a toner image is transferred onto a recording medium and is then heated to volatilize and remove the carrier liquid, and the toner particles are melted to adhere to a recording medium and cure. As the carrier liquid, an electrically insulative liquid, such as liquid hydrocarbon or silicone oil, is usually used.

Recently, from expectation of possibility of application to soft packaging, a demand for printing (image formation) on a plastic film as a recording medium is increasing. For this demand, PCT Japanese Translation Patent Publication No. 2018-533032 discloses a technology for improving adhesiveness between a plastic film as the recording medium and a toner image (toner layer) by forming a base layer of, for example, a polyvinyl alcohol resin on the plastic film.

Examples of the plastic film medium that is used in soft packaging polyolefins, such as polyethylene and polypropylene.

However, polyolefins, such as polyethylene and polypropylene, consist of hydrocarbons only and therefore hardly cause chemical interaction with toner particles forming an image, resulting in a difficulty of obtaining sufficient adhesiveness between the both in many cases. Accordingly, a technology for improving the adhesiveness between the both by forming a base layer as described above is widely used, but the fact is that such a technology is a factor of increasing the size and cost of the electrophotographic apparatus.

### SUMMARY OF THE INVENTION

The present disclosure provides a liquid developer giving excellent adhesiveness with respect to plastic film media even if a base layer is not formed.

The present disclosure relates to a liquid developer including a toner particle and a carrier liquid, wherein the toner particle contains a resin including a monomer unit (1) represented by the following formula (1):

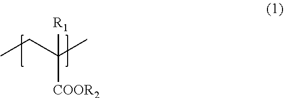

where, R₁ represents a hydrogen atom or a methyl group, and R₂ represents an alkyl group having a 6 to 18 carbon atoms or an alkenyl group having 6 to 18 carbon atoms.

Further features of the present disclosure will become apparent from the following description of exemplary embodiments with reference to the attached drawing.

### BRIEF DESCRIPTION OF THE DRAWING

The FIGURE is a diagram illustrating an example of an electrophotographic apparatus using a liquid developer.

### DESCRIPTION OF THE EMBODIMENTS

As described above, the liquid developer of the present disclosure includes a toner particle and a carrier liquid, wherein the toner particle contains a resin (hereinafter also referred to as “resin A”) including a monomer unit (1) represented by the following formula (1):

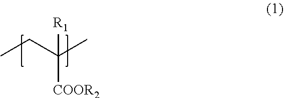

where, R₁ represents a hydrogen atom or a methyl group, and R₂ represents an alkyl group having a 6 to 18 carbon atoms or an alkenyl group having 6 to 18 carbon atoms.

When a toner particle of a resin including a monomer unit derived from a (meth)acrylate having an alkyl group having 6 to 18 carbon atoms or an alkenyl group having 6 to 18 carbon atoms is used, excellent adhesiveness with respect to a plastic film recording medium is obtained. It is inferred that this is caused by that the polarity of the toner particle becomes close to that of a plastic film (in particular, a polyolefin film) by appropriately making the resin contained in the toner particle aliphatic to improve the wettability of a toner image with respect to the plastic film.

When the number of carbon atoms of R₂ is less than 6, excellent adhesiveness with respect to a plastic film is not sufficiently obtained. When the number of carbon atoms of R₂ is larger than 18, problems such as lack of storage stability as a liquid developer may occur, and stickiness may appear on the surface of the fixed image to reduce the offset resistance.

The content of the monomer unit (1) in the resin (in the resin A) can be 17 to 83 mass % based on the total mass of the resin A. When the content is 17 mass % or more, a more excellent adhesiveness is obtained. When the content is 83 mass % or less, the storage stability of the liquid developer is further improved, and the electric field migration efficiency of the toner particle (toner migration efficiency) is improved.

The resin A can further include a monomer unit (2) represented by the following formula (2) and a monomer unit (3) represented by the following formula (3), in addition to the monomer unit (1).

When the resin A includes the monomer unit (2), the chargeability of the toner particle is improved, and the developing performance and transferability of the liquid developer are improved.

When the resin A includes the monomer unit (3), the acid value of the resin A is increased. In particular, when the liquid developer contains a basic toner particle dispersant, the carboxy group in the monomer unit (3) functions as an interaction site (binding site) with the toner particle dispersant, and the storage stability of the liquid developer is improved.

The content of the monomer unit (2) in the resin A can be 11 to 74 mass % based on the total mass of the resin A.

When the content of the monomer unit (2) is 11 mass % or more, the electric field migration efficiency of the toner particle (toner migration efficiency) is improved. In addition, when the content of the monomer unit (2) is 74 mass % or less, adhesiveness with respect to a plastic film is obtained without excessively decreasing the content of the monomer unit (1) in the resin A.

The content of the monomer unit (3) in the resin A can be 1 to 37 mass % based on the total mass of the resin A.

When the content of the monomer unit (3) is 1 mass % or more, the resin A has a sufficient acid value, and the storage stability of the liquid developer is improved. In addition, when the content of the monomer unit (3) is 37 mass % or less, adhesiveness with respect to a plastic film is obtained without excessively decreasing the content of the monomer unit (1) in the resin A.

The molar ratio of the monomer unit (1) and the monomer unit (3) in the resin A can be a monomer unit (1): monomer unit (3) of 0.5:1.0 to 15.0:1.0.

The content of the resin A in the toner particle can be 80 to 90 mass % based on the total mass of the toner particle and can be 90 to 100 mass % based on the total mass of the whole resin in the toner particle.

The toner particle included in the liquid developer of the present disclosure may further contain a resin other than the resin A.

Examples of the resin other than the resin A include an epoxy resin, a polyester resin, a polystyrene resin, an alkyd resin, and a rosin-modified resin. In addition, a combination of two or more resins can be used as needed.

The toner particle included in the liquid developer of the present disclosure may contain a coloring agent.

Examples of the coloring agent include an organic pigment, an organic dye, an inorganic pigment, a dispersion of a pigment dispersed in a dispersion medium such as an insoluble resin, and a pigment having a surface grafted with a resin.

Examples of yellow pigment include the followings: C.I. Pigment Yellows 1, 2, 3, 4, 5, 6, 7, 10, 11, 12, 13, 14, 15, 16, 17, 23, 62, 65, 73, 74, 83, 93, 94, 95, 97, 109, 110, 111, 120, 127, 128, 129, 147, 151, 154, 155, 168, 174, 175, 176, 180, 181, and 185; and C.I. Vat Yellows 1, 3, and 20.

Examples of red or magenta pigment include the followings: C.I. Pigment Reds 1, 2, 3, 4, 5, 6, 7, 8, 9, 10, 11, 12, 13, 14, 15, 16, 17, 18, 19, 21, 22, 23, 30, 31, 32, 37, 38, 39, 40, 41, 48:2, 48:3, 48:4, 49, 50, 51, 52, 53, 54, 55, 57:1, 58, 60, 63, 64, 68, 81:1, 83, 87, 88, 89, 90, 112, 114, 122, 123, 146, 147, 150, 163, 184, 202, 206, 207, 209, 238, and 269; C.I. Pigment Violet 19; and C.I. Vat Reds 1, 2, 10, 13, 15, 23, 29, and 35.

Examples of blue or cyan pigment include the followings: C.I. Pigment Blues 2, 3, 15:2, 15:3, 15:4, 16, and 17; C.I. Vat Blue 6; C.I. Acid Blue 45; and a copper phthalocyanine pigment in which 1 to 5 phthalimidomethyl groups are substituted in the phthalocyanine skeleton.

Examples of green pigment include the followings: C.I. Pigment Greens 7, 8, and 36.

Examples of orange pigment include the followings: C.I. Pigment Oranges 66 and 51.

Examples of black pigment include the followings: carbon black, titanium black, and aniline black.

Examples of white pigment include the followings: basic lead carbonate, zinc oxide, titanium oxide, and strontium titanate.

Examples of the measure for dispersing a pigment in toner particles include a ball mill, a sand mill, an attritor, a roll mill, a jet mill, a homogenizer, a paint shaker, a kneader, an agitator, a Henschel mixer, a colloid mill, a ultrasonic homogenizer, a pearl mill, and wet jet mill.

The toner particle may contain a pigment dispersant. Examples of the pigment dispersant include hydroxy group-containing carboxylates, salts of a long chain polyaminoamide and a high molecular weight acid ester, salts of high molecular weight polycarboxylic acids, high molecular weight unsaturated acid esters, high molecular copolymers, modified polyacrylates, aliphatic polycarboxylic acids, naphthalene sulfonic acid formalin condensates, polyoxyethylene alkyl phosphates, and pigment derivatives. In addition, the examples of the pigment dispersant include commercially available polymer dispersants, such as Solsperse series available from The Lubrizol Corporation.

In addition, the toner particle may contain a synergist according to the pigment as a pigment dispersion assistant.

The content of the pigment dispersant and the pigment dispersion assistant in the toner particle can be 1 to 50 parts by mass based on 100 parts by mass of the pigment.

The liquid developer of the present disclosure may include a charge-controlling agent.

Examples of the charge-controlling agent include the followings: fats and oils, such as linseed oil and soybean oil; alkyd resins; halogen polymers; aromatic polycarboxylic acids; acidic group-containing water-soluble dyes; oxidation condensation products of aromatic polyamines; metal soaps, such as cobalt naphthenate, nickel naphthenate, iron naphthenate, zinc naphthenate, cobalt octylate, nickel octylate, zinc octylate, cobalt dodecylate, nickel dodecylate, zinc dodecylate, aluminum stearate, and cobalt 2-ethylhexoate; metal sulfonates, such as petroleum metal sulfonates and metal salts of sulfosuccinates; phospholipids, such as lecithin and hydrogenated lecithin; alcohol phosphates, such as alcohol phosphonates; metal salicylates, such as a t-butyl salicylate metal complex; polyvinylpyrrolidone resins; polyamide resins; sulfonic acid-containing resins; and hydroxybenzoic acid derivatives.

The content of the charge-controlling agent in the liquid developer can be 0.01 to 10 parts by mass, preferably 0.05 to 5 parts by mass, based on 100 parts by mass of the toner particle.

The liquid developer of the present disclosure may include an additive for the purpose of improving characteristics, such as recording medium compatibility, storage stability, and image storage stability. Examples of the additive include a filler, a defoaming agent, an ultraviolet absorber, an antioxidant, an anti-fading agent, a fungicide, and an anti-rust agent.

The carrier liquid used in the present disclosure can be an electrically insulative liquid and can be a liquid having a low viscosity.

The carrier liquid can have a viscosity at 25° C. of 0.5 to 100 mPa·s, preferably, 0.5 to 20 mPa·s.

Examples of the carrier liquid include hydrocarbon-based liquids, such as dimethylbutane, dimethylpentane, octane, isooctane, decane, isodecane, decaline, nonane, dodecane, and isododecane; paraffin-based liquids, such as Isopar E, Isopar G, Isopar H, Isopar L, Isopar M, and Isopar V (Exxon Mobil Corporation), ShellSol A100 an ShellSol A150 (Shell Chemicals Japan Ltd.), and MORESCO WHITE MT-30P (MORESCO Corporation); silicone oil; and vinyl ethers.

Among these carrier liquids, paraffin-based liquids can be particularly used because they have high electrical insulation and low SP values and are in a liquid state at normal temperature.

### Method for Manufacturing Liquid Developer

The liquid developer of the present disclosure can be manufactured by, for example, a coacervation method or a wet pulverization method.

The coacervation method is described in detail in Japanese Patent Laid-Open No. 2003-241439, International Publication No. WO 2007/000974, and International Publication No. WO 2007/000975.

In the coacervation method, a coloring agent (pigment), a resin (binder resin), a solvent that dissolves the resin, and a solvent that does not dissolve the resin are mixed, and the solvent that dissolves the resin is removed from the liquid mixture to precipitate the resin that is in a dissolved state. Consequently, toner particles embedding the pigment can be dispersed in the solvent that does not dissolve the resin.

The wet pulverization method is described in detail in International Publication No. WO 2006/126566 and International Publication No. WO 2007/108485.

In the wet pulverization method, a pigment and a resin (binder resin) are kneaded at a temperature of not lower than the melting point of the resin and are then dry ground. The resulting ground product is wet pulverized in a dispersion medium functioning as the carrier liquid to manufacture a liquid developer.

### Measurement of Weight-Average Molecular Weight (Mw) of Resin a by GPC

The weight-average molecular weight (Mw) of resin A soluble in tetrahydrofuran (THF) is measured by gel permeation chromatography (GPC) as follows.

A toner is dissolved in THF at room temperature over 24 hours. The resulting solution is filtered through a solvent-resistant membrane filter having a pore diameter of 0.2 μm “Maishori Disk” (manufactured by Toso Corporation) to prepare a sample solution. The sample solution is adjusted such that the concentration of components soluble in THF is about 0.8 mass %. The measurement is performed using this sample solution under the following conditions:

Apparatus: HLC8120 GPC (detector: RI) (manufactured by Toso Corporation),
Column: connected seven columns, Shodex KF-801, 802, 803, 804, 805, 806, and 807 (manufactured by Showa Denko K.K.),
Eluent: tetrahydrofuran (THF),
Flow rate: 1.0 mL/min,
Oven temperature: 40.0° C., and
Sample injection amount: 0.10 mL.

In calculation of the molecular weight of the sample, a molecular weight calibration curve produced using a standard polystyrene resin (for example, trade name “TSK Standard Polystyrene F-850, F-450, F-288, F-128, F-80, F-40, F-20, F-10, F-4, F-2, F-1, A-5000, A-2500, A-1000, or A-500”, manufactured by Toso Corporation) is used.

The resin A can have a weight-average molecular weight (Mw) of 10000 to 15000. Method for measuring volume-average particle diameter of toner particles

The volume-average particle diameter of toner particles is measured using a laser diffraction/scattering particle diameter distribution measuring apparatus (trade name: LA-950, manufactured by Horiba, Ltd.).

The toner particles can have a volume-average particle diameter of 0.30 to 1.50 μm.

### EXAMPLES

### Example 1

### Manufacturing of Liquid Developer 1

Copolymer 1 including the following monomer units (monomer unit (1):

monomer unit (3)=7.5:1.0 (molar ratio), weight-average molecular weight (Mw): 11000): 83 parts
monomer unit (1) (R₁: methyl group, R₂: alkyl group having 12 carbon atoms): 60 mass %
monomer unit (2): 37 mass %
monomer unit (3) (R₃: methyl group): 3 mass %

Pigment (Pigment Blue 15:3): 17 parts

The materials mentioned above were sufficiently mixed with a Henschel mixer and were then melted and kneaded using a co-rotating twin screw extruder at an in-roll temperature of 100° C., and the resulting mixture was cooled and was roughly pulverized to obtain roughly pulverized toner particles.

Subsequently, 80 parts of a paraffin-based liquid (trade name: Isopar L, manufactured by Exxon Mobil Corporation), 20 parts of the roughly pulverized toner particles, and 4.5 parts of a toner particle dispersant (trade name: Ajisper PB-817, manufactured by Ajinomoto Fine-Techno Co., Inc.) were mixed with a sand mill for 36 hours to obtain a toner particle dispersion 1.

The resulting toner particle dispersion 1 was subjected to centrifugation. The supernatant was removed by decantation and was replaced with fresh Isopar L in the same mass as that of the removed supernatant, and redispersion was performed.

Thereafter, the resulting dispersion was mixed with 0.2 parts of hydrogenated lecithin (trade name: Lecinol S-10, manufactured by Nikko Chemicals Co., Ltd.) as a charge-controlling agent to obtain a liquid developer 1.

The toner particles in the liquid developer 1 had a volume-average particle diameter of 0.92 μm.

### Evaluation of Adhesiveness

Evaluation was performed using the electrophotographic apparatus (modified to enable single color development) shown in the FIGURE.

A patch having an area of 50 mm×50 mm was drawn using the liquid developer 1 on each of plastic media, a PE (polyethylene) film (trade name: Lix L6100, manufactured by Toyobo Co., Ltd.) and an OPP (oriented polypropylene) film (trade name: Pylen P2161, manufactured by Toyobo Co., Ltd.), as the recording medium 70.

The recording medium 70 was subjected to corona treatment with a corotron corona charger (not shown) prior to image transfer. Each bias condition was set to give an image density of 1.5. The secondary transfer roller 31 was heated to perform drying of the carrier liquid and heat fixing of the toner particles under conditions of a preset temperature of 110° C. and a process speed of 2 m/s.

The image density was measured using a color reflection densitometer (trade name: X-rite 500 Series, manufactured by X-rite Inc.).

The adhesiveness of the resulting fixed image was evaluated based on the cross-cut method in JIS K5600 Testing methods for paints.

Six grid-like cuts were made in the fixed image at intervals of 2 mm to form a grid of 25 squares. Adhesive tape (trade name: Nichiban No. 405) was strongly pressure-bonded to the grid. The end of the tape was peeled off at an angle of 45°, and the state of the grid was evaluated.

As a result, no peeling occurred in both the PE film and the OPP film, and the results were evaluated as A according to the following evaluation criteria: Evaluation criteria of adhesiveness

A: no peeling occurred in any square of the grid,

B: slight peeling of the image occurred at intersections of the cuts, but the area proportion of the peeling was not higher than 5%,

C: slight peeling occurred at intersections of the cuts or along the lines of the cuts in an area proportion of 5% to 35%, and

D: peeling greater than that rated as C occurred.

In addition, the offset resistance, storage stability, and toner migration efficiency of the liquid developer 1 were evaluated by the following evaluation methods and evaluation criteria.

### Evaluation of Offset Resistance

In the evaluation of adhesiveness, the toner particles offset to an intermediate transfer belt 40 were visually evaluated. When the offset toner particles were observed, it was evaluated as D, and when not observed, it was evaluated as A.

### Evaluation of Storage Stability

A liquid developer was placed in a 9-mL glass sample bottle and was stored by being left to stand in a thermostat of 40° C. for 90 days. The toner particles precipitated after 90 days were redispersed and were evaluated whether the diameter returned to the primary particle diameter (within ±10% of the volume-average particle diameter after manufacturing the liquid developer) according to the following criteria by the above-described method for measuring volume-average particle diameter.

### Evaluation Criteria of Storage Stability

A: the diameter returned to the primary particle diameter by shaking the precipitated toner,

B: the diameter returned to the primary particle diameter by loosening the precipitated toner with a dispensing spoon and shaking it,

C: the diameter returned to the primary particle diameter by loosening the precipitated toner with a dispensing spoon and performing ultrasonic dispersion, and

D: the precipitated toner could not be loosened and not be redispersed.

### Evaluation of Toner Migration Efficiency

The migration efficiency of a toner was evaluated by the following method. In the electrophotographic apparatus shown in the FIGURE, the liquid developer on the development unit 51C was adjusted to a toner concentration of 40 wt % and a solid layer thickness of 7 μm, and a solid image was developed on the photosensitive member 52C at a development bias of −200 V. During the development, the electrophotographic apparatus was stopped, and the residual developer on the development unit 51C and the developed developer on the electrophotographic photosensitive member 52C were each stripped off with tape. The reflection densities of these samples were measured with the above-described reflection densitometer, and the respective toner bearing amounts on the surfaces were calculated by a conversion table of a toner bearing amount on a surface and a reflection density prepared in advance. The migration efficiency of the toner was calculated by the following expression:

Toner migration efficiency (%)=(toner bearing amount on photosensitive member)/((toner bearing amount on photosensitive member)+(residual toner bearing amount on development unit)).

### Evaluation Criteria of Toner Migration Efficiency

A: the toner migration efficiency at a development bias of −200 V is 98% or more, B: the toner migration efficiency at a development bias of −200 V is 95% or more and less than 98%,

C: the toner migration efficiency at a development bias of −200 V is 90% or more and less than 95%, and

D: the toner migration efficiency at a development bias of −200 V is less than 90%. The results of the evaluation are shown in Table 1.

### Example 2

### Manufacturing of Liquid Developer 2

A liquid developer 2 was produced as in the manufacturing of the liquid developer 1 except that a copolymer 2 including the following monomer units (monomer unit (1): monomer unit (3)=7.5:1.0 (molar ratio), weight-average molecular weight (Mw): 12000):

monomer unit (1) (R₁: hydrogen atom, R₂: alkyl group having 12 carbon atoms): 59 mass %,
monomer unit (2): 39 mass %, and
monomer unit (3) (R₃: hydrogen atom): 2 mass %
was used instead of the copolymer 1, and was evaluated. The toner particles in the liquid developer 2 had a volume-average particle diameter of 0.88 μm. The results of the evaluation are shown in Table 1.

### Example 3

### Manufacturing of Liquid Developer 3

A liquid developer 3 was produced as in the manufacturing of the liquid developer 1 except that a copolymer 3 including the following monomer units (monomer unit (1): monomer unit (3)=3.0:1.0 (molar ratio), weight-average molecular weight (Mw): 11000):

monomer unit (1) (R₁: methyl group, R₂: alkyl group having 18 carbon atoms): 66 mass %,
monomer unit (2): 29 mass %, and
monomer unit (3) (R₃: methyl group): 6 mass %
was used instead of the copolymer 1, and was evaluated. The toner particles in the liquid developer 3 had a volume-average particle diameter of 0.85 μm. The results of the evaluation are shown in Table 1.

### Example 4

### Manufacturing of Liquid Developer 4

A liquid developer 4 was produced as in the manufacturing of the liquid developer 1 except that a copolymer 4 including the following monomer units (monomer unit (1): monomer unit (3)=7.5:1.0 (molar ratio), weight-average molecular weight (Mw): 13000):

monomer unit (1) (R₁: methyl group, R₂: alkenyl group having 12 carbon atoms): 60 mass %,
monomer unit (2): 37 mass %, and
monomer unit (3) (R₃: methyl group): 3 mass %
was used instead of the copolymer 1, and was evaluated. The toner particles in the liquid developer 4 had a volume-average particle diameter of 0.89 μm. The results of the evaluation are shown in Table 1.

### Example 5

### Manufacturing of Liquid Developer 5

A liquid developer 5 was produced as in the manufacturing of the liquid developer 1 except that a copolymer 5 including the following monomer units (monomer unit (1): monomer unit (3)=15.0:1.0 (molar ratio), weight-average molecular weight (Mw): 11000):

monomer unit (1) (R₁: methyl group, R₂: alkyl group having 12 carbon atoms): 61 mass %,
monomer unit (2): 38 mass %, and
monomer unit (3) (R₃: methyl group): 1 mass %
was used instead of the copolymer 1, and was evaluated. The toner particles in the liquid developer 5 had a volume-average particle diameter of 0.89 μm. The results of the evaluation are shown in Table 1.

### Example 6

### Manufacturing Liquid Developer 6

A liquid developer 6 was produced as in the manufacturing of the liquid developer 1 except that a copolymer 6 including the following monomer units (monomer unit (1): monomer unit (3)=7.5:1.0 (molar ratio), weight-average molecular weight (Mw): 14000):

monomer unit (1) (R₁: methyl group, R₂: alkyl group having 12 carbon atoms): 48 mass %,
monomer unit (2): 20 mass %, and
monomer unit (3) (R₃: methyl group): 32 mass %
was used instead of the copolymer 1, and was evaluated. The toner particles in the liquid developer 6 had a volume-average particle diameter of 0.92 μm. The results of the evaluation are shown in Table 1.

### Example 7

### Manufacturing of Liquid Developer 7

A liquid developer 7 was produced as in the manufacturing of the liquid developer 1 except that a copolymer 7 including the following monomer units (monomer unit (1): monomer unit (3)=16.0:1.0 (molar ratio), weight-average molecular weight (Mw): 12000):

monomer unit (1) (R₁: hydrogen atom, R₂: alkyl group having 6 carbon atoms): 71 mass %,
monomer unit (2): 27 mass %, and
monomer unit (3) (R₃: hydrogen atom): 2 mass %
was used instead of the copolymer 1, and was evaluated. The toner particles in the liquid developer 7 had a volume-average particle diameter of 0.88 μm. The results of the evaluation are shown in Table 1.

### Example 8

### Manufacturing Liquid Developer 8

A liquid developer 8 was produced as in the manufacturing of the liquid developer 1 except that a copolymer 8 including the following monomer units (monomer unit (1): monomer unit (3)=1.8:1.0 (molar ratio), weight-average molecular weight (Mw): 12000):

monomer unit (1) (R₁: methyl group, R₂: alkyl group having 18 carbon atoms): 78 mass %,
monomer unit (2): 10 mass %, and
monomer unit (3) (R₃: methyl group): 12 mass %
was used instead of the copolymer 1, and was evaluated. The toner particles in the liquid developer 8 had a volume-average particle diameter of 0.85 μm. The results of the evaluation are shown in Table 1.

### Example 9

### Manufacturing Liquid Developer 9

A liquid developer 9 was produced as in the manufacturing of the liquid developer 1 except that a copolymer 9 including the following monomer units (monomer unit (1):

monomer unit (3)=0.3:1.0 (molar ratio), weight-average molecular weight (Mw): 10000):
monomer unit (1) (R₁: hydrogen atom, R₂: alkyl group having 6 carbon atoms): 25 mass %,
monomer unit (2): 37 mass %, and
monomer unit (3) (R₃: hydrogen atom): 38 mass %
was used instead of the copolymer 1, and was evaluated. The toner particles in the liquid developer 9 had a volume-average particle diameter of 0.81 μm. The results of the evaluation are shown in Table 1.

### Example 10

### Manufacturing Liquid Developer 10

A liquid developer 10 was produced as in the manufacturing of the liquid developer 1 except that a copolymer 10 including the following monomer units (monomer unit (1): monomer unit (3)=0.4:1.0 (molar ratio), weight-average molecular weight (Mw): 12000):

monomer unit (1) (R₁: methyl group, R₂: alkyl group having 18 carbon atoms): 30 mass %,
monomer unit (2): 54 mass %, and
monomer unit (3) (R₃: methyl group): 17 mass %
was used instead of the copolymer 1, and was evaluated. The toner particles in the liquid developer 10 had a volume-average particle diameter of 0.94 μm. The results of the evaluation are shown in Table 1.

### Example 11

### Manufacturing of Liquid Developer 11

A liquid developer 11 was produced as in the manufacturing of the liquid developer 1 except that a copolymer 11 including the following monomer units (monomer unit (1): monomer unit (3)=2.5:1.0 (molar ratio), weight-average molecular weight (Mw): 11000):

monomer unit (1) (R₁: hydrogen atom, R₂: alkyl group having 6 carbon atoms): 22 mass %,
monomer unit (2): 74 mass %, and
monomer unit (3) (R₃: hydrogen atom): 4 mass %
was used instead of the copolymer 1, and was evaluated. The toner particles in the liquid developer 11 had a volume-average particle diameter of 0.89 μm. The results of the evaluation are shown in Table 1.

### Example 12

### Manufacturing of Liquid Developer 12

A liquid developer 12 was produced as in the manufacturing of the liquid developer 1 except that a copolymer 12 including the following monomer units (monomer unit (1): monomer unit (3)=3.5:1.0 (molar ratio), weight-average molecular weight (Mw): 10000):

monomer unit (1) (R₁: hydrogen atom, R₂: alkyl group having 6 carbon atoms): 18 mass %,
monomer unit (2): 80 mass %, and
monomer unit (3) (R₃: hydrogen atom): 2 mass %
was used instead of the copolymer 1, and was evaluated. The toner particles in the liquid developer 12 had a volume-average particle diameter of 0.79 μm. The results of the evaluation are shown in Table 1.

### Example 13

### Manufacturing of Liquid Developer 13

A liquid developer 13 was produced as in the manufacturing of the liquid developer 1 except that a copolymer 13 including the following monomer units (weight-average molecular weight (Mw): 12000):

monomer unit (1) (R₁: hydrogen atom, R₂: alkyl group having 6 carbon atoms): 16 mass %, and
monomer unit derived from styrene: 84 mass %
(not including monomer units corresponding to the monomer units (2) and (3))
was used instead of the copolymer 1, and was evaluated. The toner particles in the liquid developer 13 had a volume-average particle diameter of 0.81 μm. The results of the evaluation are shown in Table 1.

### Example 14

### Manufacturing of Liquid Developer 14

A liquid developer 14 was produced as in the manufacturing of the liquid developer 1 except that a copolymer 14 including the following monomer units (monomer unit (1): monomer unit (3)=1.2:1.0 (molar ratio), weight-average molecular weight (Mw): 13000):

monomer unit (1) (R₁: methyl group, R₂: alkyl group having 18 carbon atoms): 83 mass %, and
monomer unit (3) (R₃: methyl group): 17 mass %
(not including a monomer unit corresponding to the monomer unit (2))
was used instead of the copolymer 1, and was evaluated. The toner particles in the liquid developer 14 had a volume-average particle diameter of 0.89 μm. The results of the evaluation are shown in Table 1.

### Example 15

### Manufacturing of Liquid Developer 15

A liquid developer 15 was produced as in the manufacturing of the liquid developer 1 except that a copolymer 15 including the following monomer units (weight-average molecular weight (Mw): 12000):

monomer unit (1) (R₁: methyl group, R₂: alkyl group having 18 carbon atoms): 95 mass %, and
monomer unit (2): 5 mass %
(not including a monomer unit corresponding to the monomer unit (3))
was used instead of the copolymer 1, and was evaluated. The toner particles in the liquid developer 15 had a volume-average particle diameter of 0.91 μm. The results of the evaluation are shown in Table 1.

### Example 16

### Manufacturing of Liquid Developer 16

A liquid developer 16 was produced as in the manufacturing of the liquid developer 1 except that a copolymer 16 including the following monomer units (monomer unit (1): monomer unit (3)=28.2:1.0 (molar ratio), weight-average molecular weight (Mw): 12000):

monomer unit (1) (R₁: methyl group, R₂: alkyl group having 18 carbon atoms): 83 mass %,
monomer unit (2): 16 mass %, and
monomer unit (3) (R₃: methyl group): 1 mass %
was used instead of the copolymer 1, and was evaluated. The toner particles in the liquid developer 16 had a volume-average particle diameter of 0.92 μm. The results of the evaluation are shown in Table 1.

### Comparative Example 1

### Manufacturing of Liquid Developer 17

A liquid developer 17 was produced as in the manufacturing of the liquid developer 1 except that a copolymer 17 including the following monomer units (weight-average molecular weight (Mw): 12000):

unit derived from pentyl methacrylate: 15 mass %,
monomer unit (2): 83 mass %, and
monomer unit (3) (R₃: methyl group): 2 mass %
(not including a monomer unit corresponding to the monomer unit (1))
was used instead of the copolymer 1, and was evaluated. The toner particles in the liquid developer 17 had a volume-average particle diameter of 0.83 μm. The results of the evaluation are shown in Table 1.

### Comparative Example 2

Manufacturing of liquid developer 18

A liquid developer 18 was produced as in the manufacturing of the liquid developer 1 except that a copolymer 18 including the following monomer units (weight-average molecular weight (Mw): 13000):

unit derived from butyl acrylate: 16 mass %,
monomer unit (2): 81 mass %, and
monomer unit (3) (R₃: hydrogen atom): 3 mass %
(not including a monomer unit corresponding to the monomer unit (1))
was used instead of the copolymer 1, and was evaluated. The toner particles in the liquid developer 18 had a volume-average particle diameter of 0.83 μm. The results of the evaluation are shown in Table 1.

### Comparative Example 3

### Manufacturing of Liquid Developer 19

A liquid developer 19 was produced as in the manufacturing of the liquid developer 1 except that a copolymer 19 including the following monomer units (weight-average molecular weight (Mw): 13000):

unit derived from arachidyl acrylate: 84 mass %,
monomer unit (2): 15 mass %, and
monomer unit (3) (R₃: hydrogen atom): 1 mass %
(not including a monomer unit corresponding to the monomer unit (1))
was used instead of the copolymer 1, and was evaluated. The toner particles in the liquid developer 19 had a volume-average particle diameter of 0.83 μm. The results of the evaluation are shown in Table 1.

TABLE 1

| | PE | | OPP | | | Toner |
|---|---|---|---|---|---|---|
| | | Offset | | Offset | Storage | migration |
| | Adhesiveness | resistance | Adhesiveness | resistance | stability | efficiency |
| Example 1 | A | A | A | A | A | A |
| Example 2 | A | A | A | A | A | A |
| Example 3 | A | A | A | A | A | A |
| Example 4 | A | A | A | A | A | A |
| Example 5 | A | A | A | A | A | A |
| Example 6 | B | A | B | A | A | A |
| Example 7 | A | A | A | A | C | A |
| Example 8 | A | A | A | A | A | C |
| Example 9 | B | A | C | A | A | A |
| Example 10 | B | A | B | A | A | A |
| Example 11 | B | A | C | A | A | A |
| Example 12 | B | A | C | A | A | A |
| Example 13 | C | A | C | A | C | B |
| Example 14 | A | A | A | A | A | C |
| Example 15 | A | A | A | A | C | B |
| Example 16 | A | A | A | A | C | B |
| Comparative | C | A | D | A | A | A |
| Example 1 | | | | | | |
| Comparative | D | A | D | A | A | A |
| Example 2 | | | | | | |
| Comparative | A | D | A | D | D | B |
| Example 3 | | | | | | |

According to the present disclosure, it is possible to provide a liquid developer that can show excellent adhesiveness with respect to plastic film media even if a base layer is not formed.

While the present disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2019-158452, filed Aug. 30, 2019 which is hereby incorporated by reference herein in its entirety.

What is claimed is:

1. A liquid developer comprising:
a toner particle; and
a carrier liquid, wherein
the toner particle contains a resin including a monomer unit (1) represented by a formula (1): 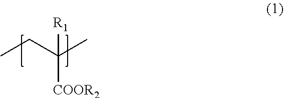
where, R₁ represents a hydrogen atom or a methyl group, and R₂ represents an alkyl group having a 6 to 18 carbon atoms or an alkenyl group having 6 to 18 carbon atoms.

2. The liquid developer according to claim 1, wherein a content of the monomer unit (1) in the resin is 17 to 83 mass % based on total mass of the resin.

3. The liquid developer according to claim 1, wherein the resin further includes a monomer unit (2) represented by a formula (2):

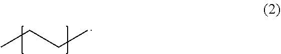

4. The liquid developer according to claim 3, wherein a content of the monomer unit (2) in the resin is 11 to 74 mass % based on total mass of the resin.

5. The liquid developer according to claim 1, wherein the resin further includes a monomer unit (3) represented by a formula (3): 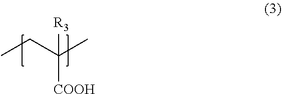
where, R₃ represents a hydrogen atom or a methyl group.

6. The liquid developer according to claim 5, wherein a content of the monomer unit (3) in the resin is 1 to 37 mass % based on total mass of the resin.

7. The liquid developer according to claim 1, further comprising:
a toner particle dispersant.

8. The liquid developer according to claim 7, wherein the toner particle dispersant is a basic toner particle dispersant.

9. The liquid developer according to claim 1, wherein a molar ratio of the monomer unit (1) and the monomer unit (3) in the resin, the monomer unit (1): the monomer unit (3), is 0.5:1.0 to 15.0:1.0.
